(19) United States
(12) Patent Application Publication
(10) Pub. No.: US 2024/0151634 A1
(43) Pub. Date: May 9, 2024

(54) ELECTRODE FOR EROSION AND/OR CORROSION MONITORING

(71) Applicant: Henkel AG & Co. KGaA, Düsseldorf (DE)

(72) Inventors: Dipak Tathe, Buldhana-Maharashtra (IN); Jayesh P. Shah, Pune (IN)

(21) Appl. No.: 18/545,073

(22) Filed: Dec. 19, 2023

Related U.S. Application Data
(63) Continuation of application No. PCT/EP2022/066277, filed on Jun. 15, 2022.

(30) Foreign Application Priority Data
Jul. 5, 2021 (IN) 202141030059

(51) Int. Cl. G01N 17/04

(52) U.S. Cl. CPC G01N 17/04

(57) ABSTRACT

The present invention relates to an electrode, comprising a) a base layer; b) a sensor layer comprising water absorbing, electrically conductive composition comprising a water soluble and/or water swellable and/or water absorbing resin; and c) a top layer, wherein said sensor layer is between said base layer and said top layer. The electrode according to the present invention can be used for erosion and/or corrosion monitoring.

### TECHNICAL FIELD

The present invention relates to an electrode, comprising a) a base layer; b) a sensor layer comprising water absorbing, electrically conductive composition comprising a water soluble and/or water swellable and/or water absorbing resin; and c) a top layer, wherein said layer of water absorbing, electrically conductive composition is between said base layer and said top layer. The electrode according to the present invention can be used for erosion and/or corrosion monitoring.

### BACKGROUND OF THE INVENTION

Typically, ceramic filled epoxy coatings are well established protective coatings to protect pump casings and propellers against corrosion and erosion. The ordinary ceramic filled epoxy coatings are typically applied on surfaces in two layers each up to from 500 to 1000 μm depending on the use and location. These coatings are used to protect a substrate from an environment, however with the time and/or due to the surrounding environment the coatings start to lose their performance and failure of coating results into a substrate degradation. In other words, erosion of the coating is followed by corrosion of the substrate. Sometimes, the erosion of the coating is visible and easy to detect, however, this is not always the case. Further the detection depends on the location where the coating material is used, sometimes the location is not detectable by eyes. For example, in the chemical process environment it is impossible continuously monitor only by eye how the coating of the containers, pipes, propellers etc. erode over the time. Equally it is difficult to keep up on monitoring the corrosion of the substrate under various coating layers.

Use of sensors is growing across the industry due to the boom in digitization and IoT. There are many sensors currently available in the market. Acoustic and vibrational sensors are well established for machine learning and structure health monitoring applications; however, they are external and not sensitive enough to detect coating erosion. There are embeddable sensors based on printed electronics which can measure stress, strain, pressure, humidity, temperature etc. and correlate to degradation of coating etc. however, it has several limitations like adhesion and compatibility with coating system and long-term stability in operating environment which includes varying pH solution, chemicals, abrasion, and sometimes high temperature. Further, many of these current sensors, which are based on printed electronics or semiconductor-based MEMs are either embedded or attached externally to the asset and have many limitations like bonding, battery life, handling reliability etc. There are passive RFID sensors in the market which offers advantage of wireless and low cost. However, they are mostly used for asset tagging etc. and have very limited industrial use for structural health monitoring application since RF signal transmission is blocked by metal and therefore do not work on a metal substrate.

Therefore, there is a need for an electrode, which is an integral part of protective coating.

### SHORT DESCRIPTION OF THE FIGURES

FIG. 1 illustrates an electrode according to the present invention on a substrate.

FIG. 2 illustrates the testing specimen (electrode) for sensor application.

FIG. 3 illustrates electrical resistance measurement of the electrode according to the present invention.

### SUMMARY OF THE INVENTION

The present invention relates to an electrode, comprising a) a base layer; b) a sensor layer comprising water absorbing, electrically conductive composition comprising a water soluble and/or water swellable and/or water absorbing resin; and c) a top layer, wherein said sensor layer is between said base layer and said top layer.

The present invention relates to a method of manufacturing an electrode according to present invention, comprising the following steps: (i) providing a base layer upon a substrate via coating, laminating, spraying, printing or brushing; (ii) which on a sensor layer comprising water absorbing, electrically conductive composition is applied via coating, laminating, spraying, printing or brushing; and (iii) applying a top layer upon the layer of water absorbing, electrically conductive composition via coating, laminating, spraying, printing or brushing.

The present invention encompasses use of the electrode according to the present invention for erosion and/or corrosion monitoring.

### DETAILED DESCRIPTION OF THE INVENTION

In the following passages the present invention is described in more detail. Each aspect so described may be combined with any other aspect or aspects unless clearly indicated to the contrary. In particular any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

As used herein, the term “consisting of” excludes any element, ingredient, member or method step not specified.

The recitation of numerical end points includes all numbers and fractions subsumed within the respective ranges, as well as the recited end points.

All percentages, parts, proportions and then like mentioned herein are based on weight unless otherwise indicated.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in disclosing the invention, including technical and scientific terms, have the meaning as commonly understood by one of the ordinary skilled in the art to which this invention belongs to. By means of further guidance, term definitions are included to better appreciate the teaching of the present invention.

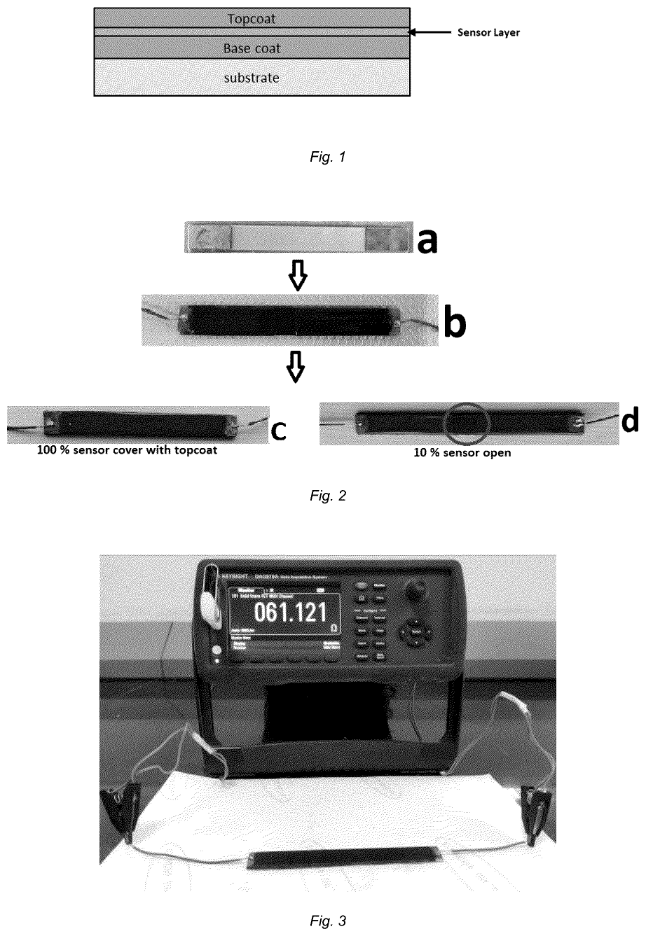

The present invention relates to an electrode, comprising a) a base layer; b) a sensor layer comprising water absorbing, electrically conductive composition comprising a water soluble and/or water swellable and/or water absorbing resin; and c) a top layer, wherein said sensor layer is between said base layer and said top layer. FIG. 1 illustrates the electrode according to the present invention.

The applicant has found out that water absorbing electrically conductive coating composition can be used as a sensor to monitor erosion of a coating and/or corrosion of a substrate. A water absorbing electrically conductive coating composition can be integrated as a sensor layer between two layers of a protective coating—a base layer and a top layer. The sensor layer is stable in resistance since it is protected under a top layer, however upon erosion of the top layer, and as the sensor layer is exposed to water, the resistance increases several folds and triggers a signal of partial damage of coating through an edge device to end user for an action. The edge device receives a raw signal from the sensor and convers it to a digital form and transmits through a wireless connection to a cloud-based software for analytics, and finally to a customer dashboard.

The present invention uses a smart conducting layer as a sensor layer between two coating layers (a base layer and a top layer) of ceramic filled epoxy based protective coating. The sensor layer comprising water absorbing, electrically conductive composition comprising a water soluble and/or water swellable and/or water absorbing resin, is protected from any fluids like water, slurry etc. by chemical and abrasion resistant top layer. The resistance under operating condition remains stable and unchanged since it is protected by a top layer. When the top layer erodes due to cavitation with time and the sensor layer made of water absorbing, electrically conductive composition comprising a water soluble and/or water swellable and/or water absorbing resin will be exposed to water. When the sensor layer comprising water absorbing, electrically conductive composition comprising a water soluble and/or water swellable and/or water absorbing resin absorbs water, resistance goes up several fold. The sudden increase in resistance may trigger an alarm based on a set threshold limit and send a signal through IoT device to an end user about partial coating damage. Since the signal is generated at the intermediate layer, operator knows the remaining life of the base layer, and therefore, can plan the downtime during slower production cycle, and this way prevent loss of equipment failure and damage.

The electrode according to the present invention comprises a base layer. Requirement for the base layer is that it provides chemical and abrasion resistant coating. Suitable base layer for use in the present invention can be any commercial coating composition.

Preferably the base layer is selected from the group consisting of epoxy-based composition, polyurethane based composition, acrylate-based composition, vinyl ester-based composition, polyester based composition, phenoxy siloxane-based composition, epoxy siloxane composition and mixtures thereof.

Particularly suitable base layer for use in the present invention may be based on a ceramic filled epoxy-based composition, which is universally used as a protective coating. For example, commercially available two component, room temperature curable, corrosion, abrasion, and chemical resistant epoxy coating system can be used in the present invention. This kind of coating systems are commonly used in protecting equipment such as pumps, pipes, heat exchangers etc. against harsh environment.

Suitable commercially available base layers for use in the present invention include but is not limited to Loctite PC 7333 from Henkel AG & Co. KGaA.

Preferably the base layer has a thickness of from 100 to 500 μm, preferably from 150 to 400 μm.

The base layer is preferably applied in two coating layers to prevent any pin holes or air bubbles which may lead to a leak path for a fluid to enter and damage the coating. For example, the base layer is added in two layers thickness of 250 μm each or thickness of 150 μm each.

The electrode according to the present invention comprises a top layer. Requirement for the top layer is that it provides chemical and abrasion resistant coating. Suitable top layer for use in the present invention can be any commercial coating composition.

Preferably, the top layer is selected from the group consisting of epoxy-based composition, polyurethane based composition, acrylate-based composition, vinyl ester-based composition, polyester based composition, phenoxy siloxane-based composition and mixtures thereof.

Particularly suitable top layer for use in the present invention may be based on a ceramic filled epoxy-based composition, which is universally used as a protective coating.

Suitable commercially available top layers for use in the present invention include but are not limited to Loctite PC 7333, Loctite PC 7255, Loctite PC 7337 and Loctite PC 7226 from Henkel AG & Co. KGaA.

Preferably the top layer has a thickness of from 100 to 600 μm, preferably from 125 to 500 μm.

If the thickness of the top layer is less than 100 μm it may not provide proper coverage what is required. Harsher the operating conditions, the thicker the top layer should be to provide a proper, reliable coverage against harsh operating conditions and environment and against chemical etching.

The top layer is preferably applied in two coating layers to prevent any pin holes or air bubbles which may lead to a leak path for a fluid to enter and damage the coating. For example, the top layer is added in two layers thickness of 300 μm each or thickness of 250 μm each.

In one embodiment the base layer is the same material as the top layer.

In one embodiment the base layer is different material as the top layer.

In one embodiment, a thin primer coating layer may be applied on a surface of a substrate before applying the base layer. Any commercially available primer coating composition suitable for a substrate in use can be used in the present invention. The optional primer layer may have a thickness of from 25 to 100 μm.

The electrode according to the present invention comprises a sensor layer comprising water absorbing, electrically conductive composition. Preferably the composition is selected from the group consisting of a vinyl resin-based composition, a 2 k epoxy-based composition, a polyester based composition, a copolymer of polyurethane and acrylate-based composition, a copolymer of polyurethane and polyester based composition, a vinyl copolymer-based composition and mixtures thereof.

In a preferred embodiment water absorbing, electrically conductive composition is based on resin selected from the group consisting of a copolymer of vinyl chloride and vinyl acetate, a polyvinyl alcohol resin, a polyvinyl butyrate resin and mixtures thereof.

These resins are preferred, because they are nonoxidizing and are permanently flexible however, still tough, and durable. Further, they are characterized by the absence of colour, odour, and taste.

Therefore, the composition comprises a resin selected from the group consisting of a vinyl resin, an epoxy resin, a polyester resin, a copolymer of polyurethane and acrylate, a copolymer of polyurethane and polyester, a vinyl copolymer resin, and mixtures thereof, preferably a vinyl resin or an epoxy resin.

A resin may be present in a water absorbing, electrically conductive composition according to the present invention in a quantity of from 5 to 25% by weight of the total weight of the composition, preferably from 7.5 to 20%, more preferably from 9 to 15%.

The water absorbing, electrically conductive composition according to the present invention comprises a water soluble and/or water swellable and/or water absorbing resin. The water soluble and/or water swellable and/or water absorbing resin can be any resin which is water soluble, or swells in the presence of water or absorbs water. Preferably, the water soluble and/or water swellable and/or water absorbing resin is selected from the group consisting of sodium polyacrylate, polyvinylpyrrolidone (PVP), cellulose ethers, methyl cellulose, hydroxyl propyl cellulose, arabic gum, starch (dextrin), casein (phosphoproteins) and mixtures thereof, more preferably selected from the group consisting of sodium polyacrylate, polyvinylpyrrolidone (PVP), methyl cellulose and mixtures thereof.

Sodium polyacrylate, polyvinylpyrrolidone (PVP) and methyl cellulose are preferred because of their excellent water solubility/water absorbing properties.

Suitable commercially available water soluble and/or water swellable and/or water absorbing resin for use in the present invention include but are not limited to sodium polyacrylate from Prime Specialities, India, polyvinylpyrrolidone (PVP) from Ashland Specialty Ingredients and methyl cellulose from DOW Chemical Company.

A water soluble and/or water swellable and/or water absorbing resin may be present in a water absorbing, electrically conductive composition according to the present invention in a quantity of from 5 to 30% by weight of the total weight of the composition, preferably from 7.5 to 25%, more preferably from 8 to 22%.

The applicant has found out that these quantities are preferred because higher quantities than 30% may lead to stability problems during application. Quantities lower than 5% may not provide desired water detection effect. Further the range from 5 to 30% of a water soluble and/or water swellable and/or water absorbing resin was found to be optimum that offers better response as a sensor.

A water absorbing, electrically conductive composition according to the present invention comprises an electrically conductive filler. In theory any electrically conductive filler may be used. Preferably, said electrically conductive filler is selected from the group consisting of carbon, carbon black, carbon nanotubes, graphite, graphene, silver, nickel, copper, gold, platinum, aluminium, iron, zinc, cobalt, lead, tin alloys, silver coated copper, silver coated graphite, silver coated polymers, silver coated aluminium, silver coated glass, silver coated carbon, silver coated boron nitride, silver coated aluminium oxide, silver coated aluminium hydroxide and mixtures thereof, more preferably selected from the group consisting of carbon black, carbon nanotubes, graphite and mixtures thereof.

In one embodiment the electrically conductive filler is carbon black.

In one embodiment the electrically conductive filler is carbon nanotubes.

In one embodiment the electrically conductive filler is graphite.

Yet in another embodiment the electrically conductive filler is a mixture of carbon black and graphite.

Yet in another embodiment the electrically conductive filler is a mixture of carbon black, graphite, and carbon nanotubes.

Suitable commercially available electrically conductive fillers for use in the present invention include but are not limited to Timrex SGF 15 from Imerys Graphite & Carbon and Vulcan PF from Cabot Corporation, Vulcan XC 72 from Cabot Corporation

An electrically conductive filler may be present in a water absorbing, electrically conductive composition according to the present invention in a quantity of from 10 to 35% by weight of the total weight of the composition, preferably from 12 to 33%, more preferably from 15 to 30%.

When the electrically conductive filler is any of carbon black, carbon nanotubes or graphite the quantity may also depend on the oil absorption number. The oil absorption number is different for carbon black, carbon nanotubes and graphite and it depends on the particle size and a specific surface area of the conductive filler. For example, carbon nanotubes have small particle size in nano scale, and therefore, it has high oil absorption value. As a general guidance, higher the oil absorption number, lower the particle quantity. The oil absorption number is measured according to ASTM-D281.

The applicant has found out that these quantities are preferred because higher quantities than 25% may lead to rheology problems during application. Whereas quantities lower than 5% may not provide desired adhesion to the substrate/under coat/over coat layers.

A water absorbing, electrically conductive composition according to the present invention comprises a solvent. Suitable solvent for use in the present invention has a boiling point less than 235° C. Preferably said solvent is selected from the group consisting of n-butanol, butylcarbitol, 1-methoxy-2-propanol acetate, isopropyl alcohol, butyl cellosolve and mixtures thereof, more preferably selected from the group consisting of n-butanol, butylcarbitol, 1-methoxy-2-propanol acetate and mixtures thereof.

Preferred solvents n-butanol, butylcarbitol, 1-methoxy-2-propanol acetate are desired because they are polar solvents and action during composition processability. Further, these solvents also act as coalescing agents in the composition.

Suitable commercially available solvent for use in the present invention include but is not limited to n-Butanol from Sigma Aldrich.

A solvent may be present in a water absorbing, electrically conductive composition according to the present invention in a quantity of from 10 to 70% by weight of the total weight of the composition, preferably from 20 to 65%, more preferably from 30 to 60%.

This solvent quantity range is preferred because it provides good applicability (composition) on a substrate.

The sensor layer comprising water absorbing, electrically conductive composition according to the present invention may have a thickness of from 10 to 300 μm, preferably from 50 to 200 μm and/or may have an electrical resistance of from 5Ω to 800Ω, preferably from 20 106 to 500Ω, wherein the electrical resistance is measured according to ASTM D2739-97.

The thickness range is preferred, because the thickness less than 10 μm may not be possible to apply homogeneously due to expected ink rheology and available application methods. The thickness greater than 300 μm may cause cracking. In addition, it may increase overall coating thickness which may lead parts tolerance issue. By a tolerance issue is meant herein increase of the total thickness of the electrode i.e., combined thickness of a base layer, a sensor layer and a top layer is getting too high, and it may reduce the inner dimeter of a pump for example, and therefore it adversely affects the tolerance diameter of the pump.

The resistance range is preferred because resistance less than 5Ω may not be reliable reached with carbon-based ink and whereas resistance greater than 800Ω may lead to poor sensor sensitivity.

The sensor layer covers completely or partially the base layer. The degree of the coverage depends on the application. Some non-limiting examples of full coverage would be small pump housings.

Whereas the top layer covers completely the sensor layer.

The present invention relates to a method of manufacturing an electrode according to the present invention, comprising the following steps: (i) providing a base layer upon a substrate via coating, laminating, spraying, printing or brushing; (ii) which on a sensor layer comprising water absorbing, electrically conductive composition is applied via coating, laminating, spraying, printing or brushing; and (iii) applying a top layer upon the layer of water absorbing, electrically conductive composition via coating, laminating, spraying, printing or brushing.

In a preferred embodiment and in step (ii) the sensor layer comprising water absorbing, electrically conductive composition covers fully or partially the surface of the base layer and wherein step (iii) the top layer fully covers the surface of the layer of water absorbing, electrically conductive composition.

In the method according to the present invention after an application of a sensor layer comprising water absorbing, electrically conductive composition, the sensor layer is cured for 10 min to 10 hours, preferably for 30 min to 8 hours.

In the method according to the present invention, and after the application of a sensor layer comprising water absorbing, electrically conductive composition, the sensor layer is cured at 20 to 150° C., more preferably at 25 to 100° C.

In the method according to the present invention, and after the application of base layer (step (i)) and after the application of the top layer (step (iii)), the base layer and/or the top layer is cured for 10 min to 10 hours, preferably for 30 min to 8 hours, wherein the cure time may be same or different for the base layer and the top layer.

In the method according to the present invention, and after the application of base layer (step (i)) and after the application of the top layer (step (iii)), the base layer and/or the top layer is cured at 20 to 150° C., more preferably at 25 to 100° C., wherein the cure temperature may be same or different for the base layer and the top layer.

The present invention relates to use of the electrode according to the present invention for erosion and/or corrosion monitoring.

In one embodiment the electrode according to the present invention is used to detect erosion and/or corrosion from the surface of the substrate.

In one embodiment the electrode according to the present invention is used to detect erosion and/or corrosion from the top layer.

In one embodiment the electrode according to the present invention is used to detect erosion and/or corrosion from the base layer.

For an example, the electrode can be used in pump housing, propeller, or storage tank shell for erosion and/or corrosion monitoring.

### EXAMPLES

Following chemicals are used in the examples:
Timrex SGF 15 from Imerys Graphite & Carbon
Vulcan PF and Vulcan XC 72 from Cabot Corporation
Arcosolv PM Acetate from Lyondell Chemical Company
Butylcarbitol from Dow Chemical Company
UCAR Wagh from Dow Chemical Company
Polyvinylpyrrolidone (PVP) from Ashland Specialty Ingredients
Methyl cellulose from DOW Chemical Company
n-Butanol from Sigma Aldrich
Sodium Polyacrylate from Prime Specialities, India

The compositions comprising PVP or Methocel VLV based water absorbing polymer in a thermoplastic binder are shown in table 1 below. Compositions comprising 10 and 20% of PVP and Methuen VLV were prepared in high-speed mixer at 2000 rpm for 30 min.

TABLE 1

| | Exam- | Exam- | Exam- | Exam- | Exam- |
|---|---|---|---|---|---|
| Material | ple 1 | ple 2 | ple 3 | ple 4 | ple 5 |
| Timrex SGF 15 | 13.39 | 13.5 | 12 | 13.5 | 12 |
| Vulcan PF | — | 6.75 | 6 | 6.75 | 6 |
| Vulcan XC 72 | 13.39 | — | — | — | — |
| n-Butanol | 57.15 | — | — | — | — |
| Arcosolv PM | — | 19.17 | 17.04 | 19.17 | 17.04 |
| Acetate | | | | | |
| Butylcarbitol | — | 38.43 | 34.16 | 38.43 | 34.16 |
| UCAR Vagh | — | 12.15 | 10.8 | 12.15 | 10.8 |
| PVP | 16.07 | 10 | 20 | | |
| Methocel VLV | — | — | — | 10 | 20 |
| % Solid | 42.85 | 42.4 | 48.8 | 42.4 | 48.8 |
| % Filler | 26.78 | 20.25 | 18 | 20.25 | 18 |
| P/B ratio | 1.67 | 0.91 | 0.58 | 0.91 | 0.58 |

### Testing Electrode Preparation and Electrode Application

The composite specimen having dimensions 125×12.7×3 mm was used in the performance study of the electrode. Copper leads of 50 μm thick were attached by using cyanoacrylate adhesive at both ends of composite specimen. These copper leads were used for soldering the wire for measuring the resistance of the coated specimen. The specimen was prepared by applying the three layers of coating. A base layer of Loctite PC 7333 (from Henkel AG & Co. KGaA) having thickness 200 μm, followed by application of a layer of water absorbing, electrically conductive composition comprising a water soluble and/or water swellable and/or water absorbing resin having thickness of 100 μm and a top layer of Loctite PC 7333 (from Henkel AG & Co. KGaA) having thickness if 200 μm. The image of specimen is shown in the FIG. 2. FIG. 2 illustrates 2a) bare specimen, 2b) base layer +a layer of water absorbing, electrically conductive composition (sensor layer), 2c) 100% a layer of water absorbing, electrically conductive composition (sensor layer) covered with top layer, 2d) 90% a layer of water absorbing, electrically conductive composition (sensor layer) covered with top layer, 10% was open. The Base layer was cured at 100° C. for 1 hour; sensory layer was cured at 100° C. for 1 hour and top layer was cured at 100° C. for 1 hour.

The electrode was evaluated by using a water drop test. Water drop test was performed by adding 2 to 3 drops of water at the centre of the coated specimen and the electrical resistance was recorded before and after addition of water drops. The electrical resistance of specimens was measured by using Keysight DAQ970A-Data Acquisition System (the system is illustrated in FIG. 3).

The change in electrical resistance after adding the water drops over the electrode at the centre was recorded from 0 minute to 10 min. The specimen fully covered with the top layer Loctite PC 7333, the electrode did not show any change in electrical resistance after adding the drops of water over the specimen (FIG. 2c). But the layer of water absorbing, electrically conductive composition comprising a water soluble and/or water swellable and/or water absorbing resin (sensor) was not fully covered with top layer (FIG. 2b). When 90% of layer of water absorbing, electrically conductive composition comprising a water soluble and/or water swellable and/or water absorbing resin (sensor) was covered with the top layer Loctite PC 7333 (FIG. 2d) and water drops were added on the top layer the change in electrical resistance was shown. The water drops test results of open electrode specimen are shown in the table 2. Example 1 showed the high change in electrical resistance in 10 min i.e., 27054%, whereas example 4 showed 25.86% change in electrical resistance. The electrical resistance of the electrode was changed by adding the water drops over the electrically conductive coating, because water absorbing polymer absorb the water and conducting path was disconnected.

TABLE 2

| | Example no. | | | | | | |
|---|---|---|---|---|---|---|---|
| Time | Example-1 | Example-2 | Example-3 | | Example-4 | | Example-5 |
| Initial | 68.86 Ω | 1.57 KΩ | 51.6 | KΩ | 42 | Ω | 92.99 Ω |
| Resistance, 1 min | 9700 Ω | 1.87 KΩ | 114.8 | KΩ | 43.4 | Ω | 106.7 Ω |
| % change | 13985 | 18.6 | 122 | | 2.35 | | 14.7 |
| Resistance, 2 min | 18400 Ω | 5.43 KΩ | 138.5 | KΩ | 44.36 | Ω | 121.9 Ω |
| % change | 26618 | 244.6 | 168 | | 4.63 | | 31.1 |
| Resistance, 5 min | 18050 Ω | 9.23 KΩ | 186 | KΩ | 46.86 | Ω | 165.7 Ω |
| % change | 26110 | 485.8 | 260 | | 10.53 | | 78.2 |
| Resistance, 10 min | 18700 Ω | 9.9 KΩ | 248.7 | KΩ | 53.35 | Ω | 216.7 Ω |

| | | | | | |
|---|---|---|---|---|---|
| % change | 27054 | 528 | 381 | 25.86 | 133 |

### Comparative Example

Table 3 below exemplify a composition without a water soluble and/or water swellable and/or water absorbing resin. The composition was prepared in high-speed mixer at 2000 rpm for 30 min.

TABLE 3

| Material | Comparative example 6 |
|---|---|
| Timrex SGF 15 | 15 |
| Vulcan PF | 7.5 |
| Arcosolv PM Acetate | 21.3 |
| Butylcarbitol | 42.7 |
| UCAR Wagh | 13.5 |
| Sodium Polyacrylate | — |
| % Solid | 36 |
| % Filler | 22.5 |
| P/B ratio | 1.67 |

Substrate was coated with the composition according to example 6 and were used to perform the water drop test. The results of water drop test for the comparative example 6 is shown in the table 4 below. Comparative example 6 did not shown any change in electrical resistance after 5 min.

TABLE 4

| Time | Comparative example 1a |
|---|---|
| Resistance, 0 min, Ω | 33.78 |
| Resistance, 5 min, Ω | 33.79 |
| % Change-5 min, | 0.03 |
| Resistance, 10 min, Ω | — |
| % Change-10 min | — |
| Resistance, 30 min, Ω | — |
| % Change-30 min | — |

1. An electrode, comprising
a) a base layer;
b) a sensor layer comprising water absorbing, electrically conductive composition comprising a water soluble and/or water swellable and/or water absorbing resin; and
c) a top layer,
wherein said sensor layer is between said base layer and said top layer.

2. The electrode according to claim 1, wherein the water absorbing, electrically conductive composition is selected from the group consisting of a vinyl resin-based composition, a 2 k epoxy-based composition, a polyester based composition, a copolymer of polyurethane and acrylate-based composition, a copolymer of polyurethane and a polyester based composition, a vinyl copolymer based composition and mixtures thereof, preferably a vinyl resin-based composition or a 2 k epoxy-based composition.

3. The electrode according to claim 1, wherein the water absorbing, electrically conductive composition comprising a water soluble and/or water swellable and/or water absorbing resin selected from the group consisting of sodium polyacrylate, polyvinylpyrrolidone (PVP), cellulose ethers, methyl cellulose, hydroxyl propyl cellulose, arabic gum, starch (dextrin), casein (phosphoproteins) and mixtures thereof, more preferably selected from the group consisting of sodium polyacrylate, polyvinylpyrrolidone (PVP), methyl cellulose and mixtures thereof.

4. The electrode according to claim 1, wherein the sensor layer
(i) has a thickness of from 1 to 300 μm, preferably from 10 to 200 μm;
and/or
(ii) has an electrical resistance of from 5Ω to 800 kΩ, preferably from 20Ω to 500 kΩ,
wherein the electrical resistance is measured according to ASTM D2739-97.

5. The electrode according to claim 1, wherein the base layer is selected from the group consisting of epoxy-based composition, polyurethane based composition, acrylate-based composition, vinyl ester-based composition, polyester based composition, phenoxy siloxane-based composition, epoxy siloxane composition and mixtures thereof,
and has a thickness of from 100 to 500 μm, preferably from 150 to 400 μm.

6. The electrode according to claim 1, wherein the top layer is selected from the group consisting of epoxy-based composition, polyurethane based composition, acrylate-based composition, vinyl ester-based composition, polyester based composition, phenoxy siloxane-based composition and mixtures thereof
and has a thickness of from 100 to 600 μm, preferably from 125 to 500 μm.

7. The electrode according to claim 1, wherein the base layer is same material as the top layer or wherein the base layer is different material as the top layer.

8. A method of manufacturing an electrode according to claim 1, comprising the following steps:
(i) providing a base layer upon a substrate via coating, laminating, spraying, printing or brushing;
(ii) which on a sensor layer comprising a water absorbing, electrically conductive composition is applied via coating, laminating, spraying, printing or brushing; and
(iii) applying a top layer upon the layer of water absorbing, electrically conductive composition via coating, laminating, spraying, printing or brushing.

9. The method of claim 8, wherein in step (ii) the sensor layer comprising water absorbing, electrically conductive composition covers fully or partially the surface of the base layer and wherein step (iii) the top layer fully covers the surface of the layer of water absorbing, electrically conductive composition.

10. The method according to claim 8, wherein after the application of a sensor layer comprising water absorbing, electrically conductive composition, the sensor layer is cured for 10 min to 10 hours, preferably for 30 min to 8 hours.

11. The method according to claim 8, wherein after the application of a sensor layer comprising water absorbing, electrically conductive composition the layer is cured at 20 to 150° C., more preferably at 25 to 100° C.

12. The method according to claim 8, wherein after the application of base layer (step (i)) and after the application of the top layer (step (iii)), the base layer and/or the top layer is cured for 10 min to 10 hours, preferably for 30 min to 8 hours, wherein the cure time may be same or different for the base layer and the top layer.

13. The method according to claim 8, wherein after the application of base layer (step (i)) and after the application of the top layer (step (iii)), the base layer and/or the top layer is cured at 20 to 150° C., more preferably at 25 to 100° C., wherein the cure temperature may be same or different for the base layer and the top layer.

14. (canceled)
